(19) United States
(12) Patent Application Publication
(10) Pub. No.: US 2012/0084176 A1
(43) Pub. Date: Apr. 5, 2012

(54) ARTICLE SEARCH SYSTEM, INFORMATION PROCESSING TERMINAL, AND INFORMATION PROVIDING METHOD

(75) Inventor: Shigeaki Suzuki, Shizuoka (JP)

(73) Assignee: TOSHIBA TEC KABUSHIKI KAISHA, Tokyo (JP)

(21) Appl. No.: 13/248,392

(22) Filed: Sep. 29, 2011

(30) Foreign Application Priority Data
Sep. 30, 2010 (JP) 2011-222473

(51) Int. Cl. G06Q 30/00

(52) U.S. Cl. 705/26.9

(57) ABSTRACT

According to one embodiment, an article search system includes an information processing terminal, and a storage unit. The storage unit stores a salesfloor map of a store and article information and a display position of an article sold. The information processing terminal includes a display unit, an operation unit, a first control section, and a second control section. The first control section causes the display unit to display the salesfloor map stored in the storage unit. The second control section, when a selling space included in the salesfloor map displayed on the display unit is designated by operating the operation unit, causes the display unit to display the article information of an article whose display position is the selling space stored in the storage unit.

### CROSS-REFERENCE TO RELATED APPLICATIONS

This application is based upon and claims the benefit of priority from prior Japanese Patent Application No. 2010-222473, filed on Sep. 30, 2010, the entire contents of which are incorporated herein by reference.

### FIELD

Embodiments described herein relate generally to an article search system for searching for articles sold on each salesfloor in various stores, an information processing terminal used in this system, and an information providing method for providing information to a user.

### BACKGROUND

In a store such as a supermarket or home center, a number of articles are displayed by category such as foodstuffs or clothing, and grasping of the place where a specific article is displayed may not be easy. Therefore, some customers cannot find out the place where an article they want is displayed, and give up purchasing the article. Some other customers feel frustrated by the hindrance to smooth shopping experience.

Recently, many large stores are built in the suburbs of cities. In such large stores, many shelves for articles are arranged in one floor and passages for customers are often complicated. Therefore, grasping the place where a specific article is displayed is even more difficult.

Moreover, if a customer searches around for a desired article in a store that the customer visits but the article is not sold there, the customer becomes disappointed. In such case, the customer may have an impression that the store has a poor article lineup.

In view of such circumstances, measures need to be taken to enable easy confirmation of articles sold in a store and the display positions of the articles.

### BRIEF DESCRIPTION OF THE DRAWINGS

FIG. 1 shows an overall configuration of an article search system according to an embodiment.

FIG. 2 shows a preferable form of a customer terminal in the embodiment.

FIG. 3 is a block diagram showing the configuration of essential parts of a server device in the embodiment.

FIG. 4 is a block diagram showing the configuration of essential parts of the customer terminal in the embodiment.

FIG. 5 is a schematic diagram showing an exemplary data structure of an article master in the embodiment.

FIG. 6 illustrates a hierarchized salesfloor of a store in the embodiment.

FIG. 7 is a schematic diagram showing an exemplary data structure of a map information file in the embodiment.

FIG. 8 is a functional block diagram of the article search system according to the embodiment.

FIG. 9 is a flowchart for explaining operations in the embodiment.

FIG. 10 is a flowchart for explaining operations in the embodiment.

FIG. 11 is a flowchart for explaining operations in the embodiment.

FIG. 12 shows an example of a display screen where an overall salesfloor map is displayed, in the embodiment.

FIG. 13 shows an example of a display screen where an enlarged salesfloor map is displayed, in the embodiment.

FIG. 14 shows an example of a display screen where a detailed salesfloor map is displayed, in the embodiment.

FIG. 15 shows an example of a display screen where article information is displayed, in the embodiment.

### DETAILED DESCRIPTION

In general, according to one embodiment, an article search system includes an information processing terminal, and a storage unit.

The storage unit stores a salesfloor map of a store and article information and a display position of an article sold.

The information processing terminal includes a display unit, an operation unit, a first control section, and a second control section. The display unit displays information. The operation unit accepts a user's operation. The first control section causes the display unit to display the salesfloor map stored in the storage unit. The second control section, when a selling space included in the salesfloor map displayed on the display unit is designated by operating the operation unit, causes the display unit to display the article information of an article whose display position is the selling space stored in the storage unit.

Hereinafter, an embodiment will be described with reference to the drawings. In the following embodiment, the same parts of the configuration are denoted by the same reference numerals and overlapping explanation is only given when necessary.

### System Configuration

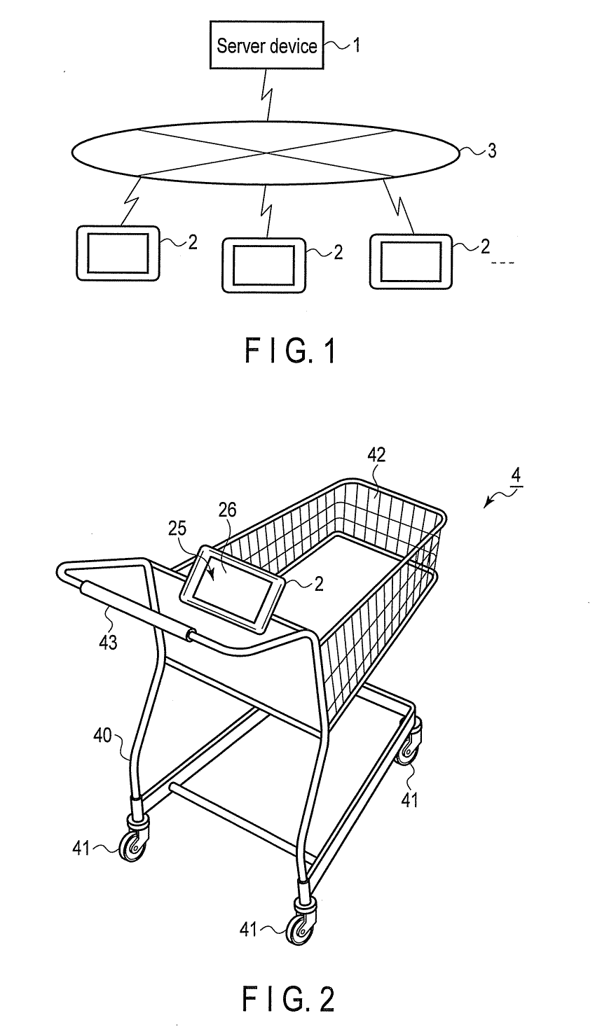

FIG. 1 is a schematic diagram showing the overall configuration of an article search system according to this embodiment. This system includes a server device 1 and plural customer terminals 2 functioning as information processing terminals in this embodiment, with the server device 1 and the customer terminals 2 being connected to a network 3 such as the Internet or a LAN (local area network) or the like in the store. Providing various kinds of information to customers as users of the customer terminals 2 in this article search system is an information providing method according to this embodiment.

The server device 1 is, for example, a store server provided in the backyard of a store to be a target of article search using this article search system. Alternatively, the server device 1 may be a server device provided at the headquarters operating the store.

Each customer terminal 2 is a communication terminal such as a personal computer installed at the customer's home or a mobile phone, or a small-size terminal lent to the customer in the store. Each customer terminal 2 has a display unit, an operation unit, and a measure to communicate mutually with the server device 1 via the network 3.

A preferable form of the customer terminal 2 lent to the customer in the store is shown in FIG. 2. This customer terminal 2 has a display 25 that is an LCD (liquid crystal display) including a touch panel 26, and is attached to a shopping trolley 4 lent to the customer in the store.

The shopping trolley 4 has four wheels 41, a shopping basket 42 opened on its top for housing articles, and a handle 43, which are attached to a frame 40. The shopping trolley 4 can be self-propelled in forward, backward, left and right directions via each wheel 41. The customer terminal 2 is attached to a part on the frame 40 situated between the handle 43 and the shopping basket 42 so that the customer holding the handle 43 can easily see a display screen of the display 25.

### Server Device

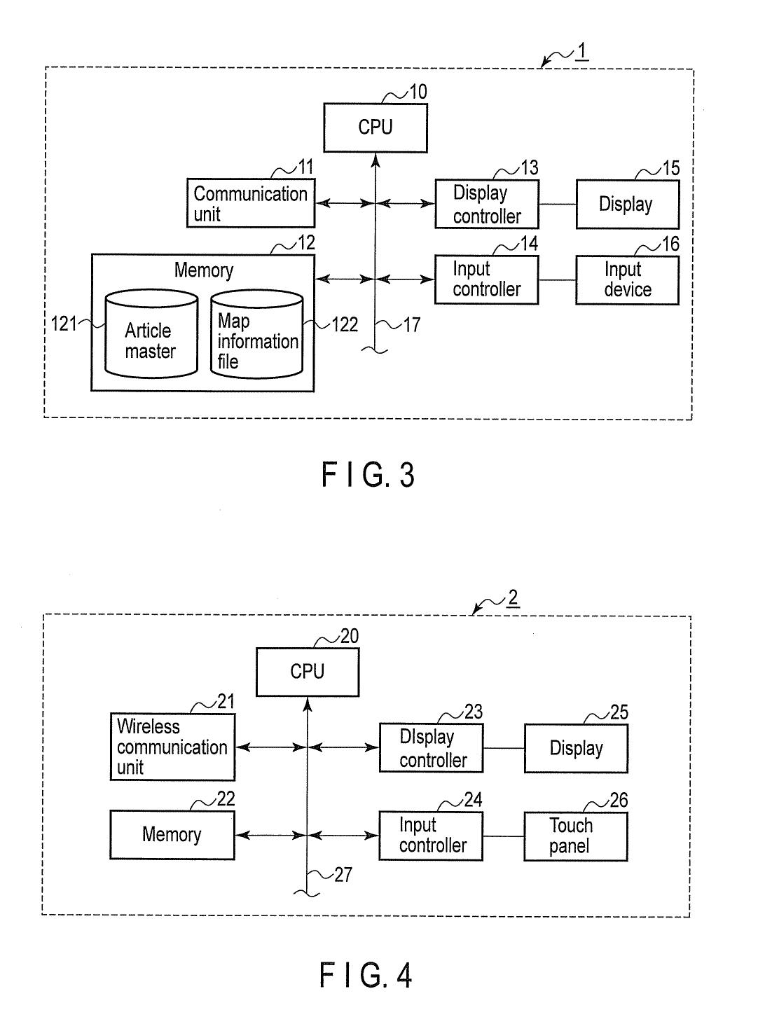

FIG. 3 is a block diagram showing the configuration of essential parts of the server device 1 functioning as the storage unit in the embodiment. The server device 1 includes a CPU (central processing unit) 10 functioning as a control center, a communication unit 11, a memory 12, a display controller 13, an input controller 14, a display 15 connected with the display controller 13, and an input device 16 such as a keyboard or mouse connected with the input controller 14. The CPU 10 is connected with the communication unit 11, the memory 12, the display controller 13 and the input controller 14 via a bus line 17 configured in the form of an address bus or data bus.

The communication unit 11 controls communication with each customer terminal 2 carried out via the network 3. The memory 12 is configured in the form of a ROM (read only memory) or RAM (random access memory) and stores a control program executed by the CPU 10, an article master 121, a map information file 122 and the like. The article master 121 and the map information file 122 will be described later in detail with reference to FIG. 5 to FIG. 7.

The display 15 is, for example, an LCD. The display controller 13 causes the display 15 to display various kinds of information in response to instructions from the CPU 10. The input device 16 outputs a signal corresponding to a user's operation. The input controller 14 takes in the signal outputted from the input device 16 and outputs the signal to the CPU 10.

### Customer Terminal

FIG. 4 is a block diagram showing the configuration of essential parts of the customer terminal 2 shown in FIG. 2. This customer terminal 2 has a CPU 20 functioning as a control center, a wireless communication unit 21, a memory 22, a display controller 23, an input controller 24, the display 25 connected with the display controller 23, and the touch panel 26 connected with the input controller 24. The CPU 20 is connected with the wireless communication unit 21, the memory 22, the display controller 23 and the input controller 24 via a bus line 27 configured in the form of an address bus or data bus.

The wireless communication unit 21 wirelessly communicates by radio waves with an access point, not shown, connected to the network 3, and controls mutual communication with the server device 1 carries out via this access point. The memory 22 is configured in the form of a ROM or RAM and stores a control program of the customer terminal 2 and the like.

The display controller 23 causes the display 25 to display a screen including various GUIs (graphical user interfaces) in response to instructions from the CPU 20. The input controller 24 takes in an electrical signal outputted from the touch panel 26 according to a touch operation position, then calculates the coordinates of the touch operation position, compares the coordinates with the display position coordinates of each GUI displayed on the display 25, and when there is a GUI with the matching coordinates, notifies the CPU 20 that this GUI is operated.

Each part of the customer terminal 2 operates by being supplied with power from a battery, not shown. This battery is connected with a predetermined cable and is charged with electricity, for example, when the shopping trolley 4 equipped with the customer terminal 2 is on standby in a trolley yard provided at a doorway or the like of the store.

### Data Structure

Next, the data structures of the article master 121 and the map information file 122 will be described.

FIG. 5 is a schematic diagram showing an exemplary data structure of the article master 121. The article master 121 includes records in which article information such as article name and unit price, and one or plural pieces of display position information are set in relation to a JAN code as an identification code of each article sold in the store. For example, in the illustrated top record, an article name “onion dressing 130 ml”, unit price “399”, display position information “foodstuffs—seasoning—dressing”, “foodstuffs—meat—beef” and the like are set in relation to a JAN code “JAN001”.

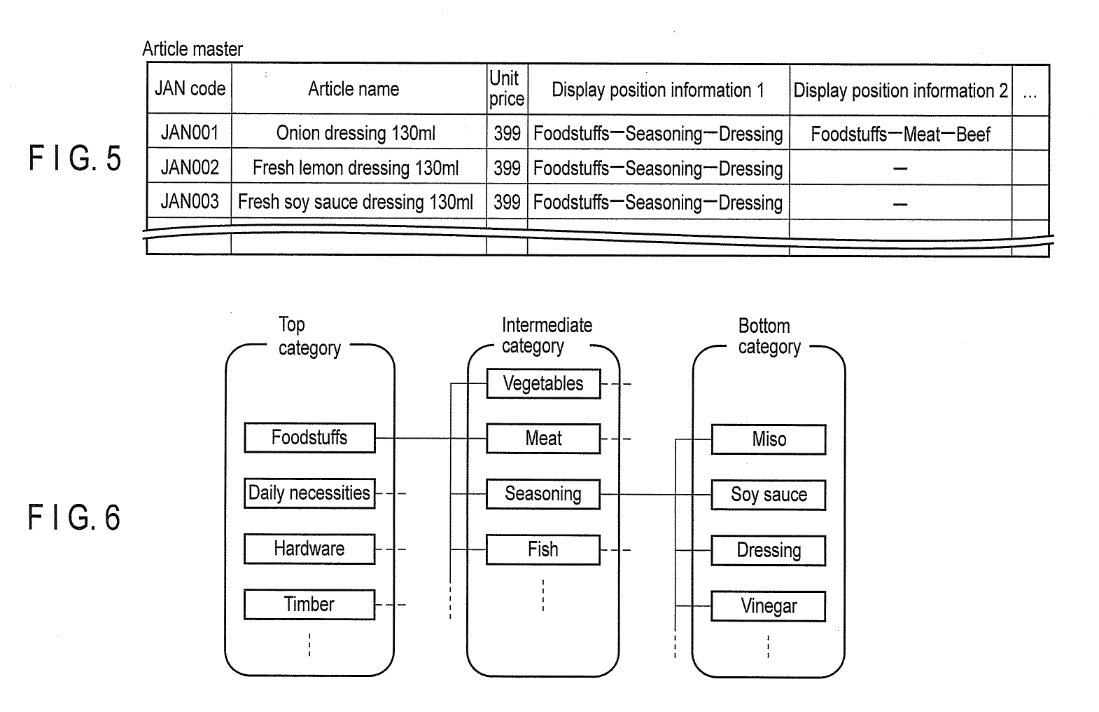

In the salesfloor of a store that is a search target of the article search system, hierarchized categories are defined, for example, as shown in FIG. 6. In the illustrated example, “foodstuffs”, “daily necessities”, “hardware”, “timber” and the like are top categories. Below each of these top categories, intermediate categories are defined. For example, “vegetable”, “meat”, “seasoning”, “fish” and the like are defined as the intermediate categories below “foodstuffs”. Moreover, bottom categories are defined below each intermediate category. For example, “miso”, “soy sauce”, “dressing”, “vinegar” and the like are defined as the bottom categories below “seasoning”.

According to these three types of categories of top, intermediate, and bottom, the display position information of each article in the article master 121 is described. For example, the display position information “foodstuffs—seasoning—dressing” of the article of the above JAN code “JAN001” indicates that this article is displayed in a “dressing” selling space in a “seasoning” selling space within a “foodstuffs” selling space.

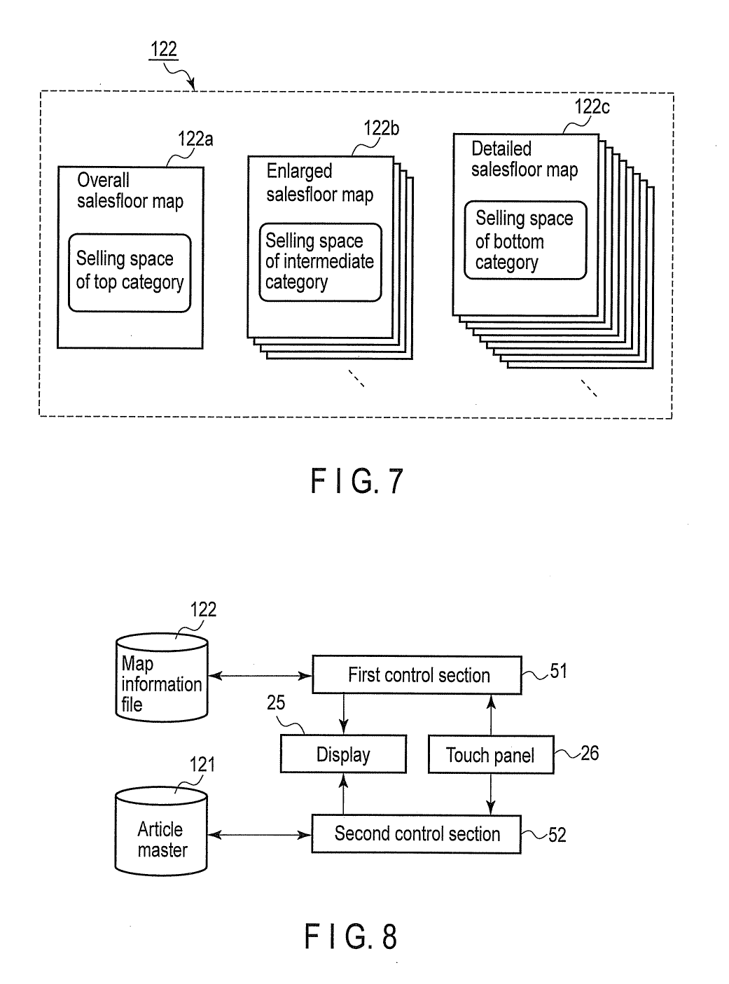

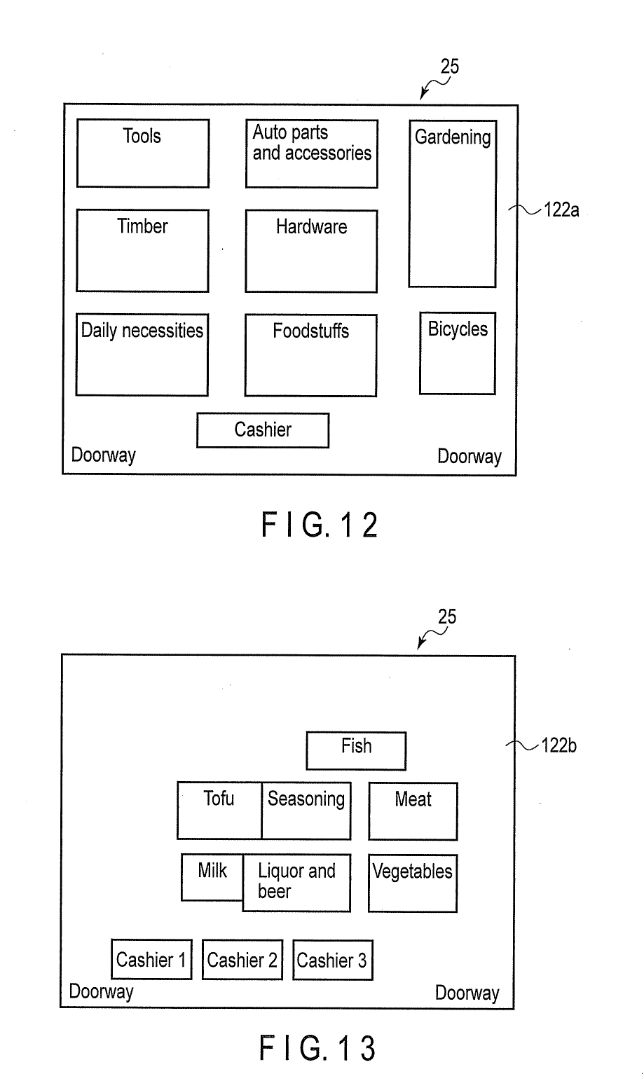

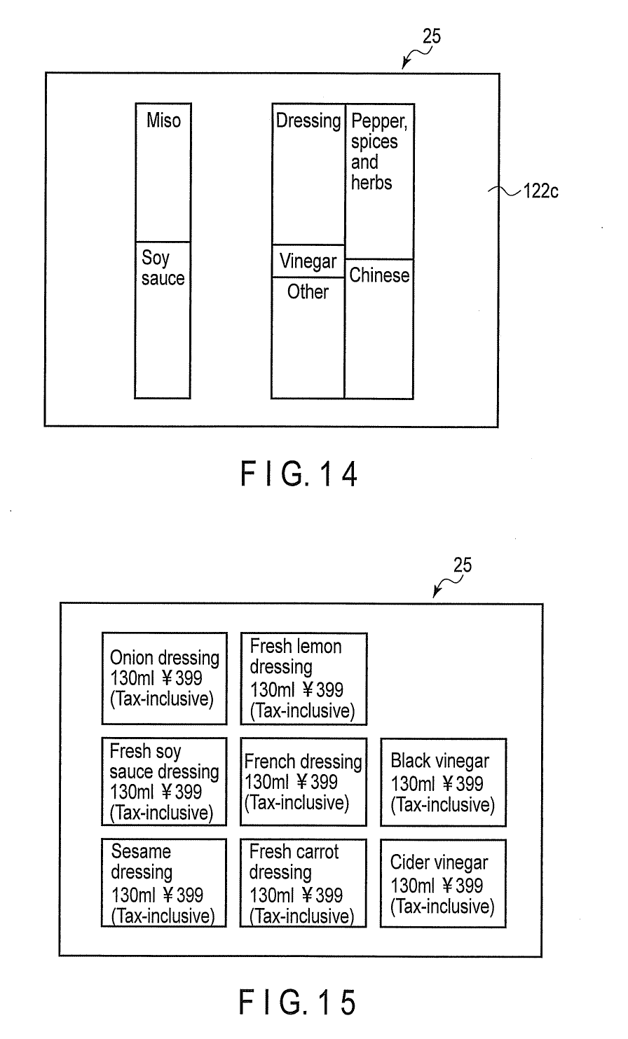

FIG. 7 is a schematic diagram showing an exemplary data structure of the map information file 122. The map information file 122 includes one overall salesfloor map 122a, enlarged salesfloor maps 122b in the same number as the selling spaces belonging to the top categories, and detailed salesfloor maps 122c in the same number as the selling spaces belonging to the intermediate categories. The overall salesfloor map 122a is formed by arranging each selling space belonging to the top categories in an overall map of the store (see FIG. 12). The enlarged salesfloor map 122b is provided for each selling space belonging to the top categories. Each enlarged salesfloor map 122b is formed by arranging each selling space of the intermediate categories belonging to the corresponding top category in a store map that is slightly enlarged from the overall salesfloor map 122a (see FIG. 13). The detailed salesfloor map 122c is provided for each selling space belonging to the intermediate categories. Each detailed salesfloor map 122c is formed by arranging each selling space of the bottom categories belonging to the corresponding intermediate category in a map that is further enlarged from the enlarged salesfloor map 122b (see FIG. 14).

In this manner, the salesfloor maps of the store are hierarchically configured in order from the overall salesfloor map 122a showing rough divisions of the arrangement in the salesfloor of the store to the enlarged salesfloor maps 122b and the detailed salesfloor maps 122c showing more detailed arrangements in the salesfloor.

### Functional Blocks

FIG. 8 shows a functional block diagram of the article search system according to the embodiment.

The article search system according to the embodiment has a first control section 51 and a second control section 52 as main control functions.

The first control section 51 causes the display 25 to display the salesfloor maps saved in the map information file 122.

When a selling space included in the salesfloor maps displayed on the display 25 is designated by operating the touch panel 26, the second control section 52 causes the display 25 to display the article information of the article whose display portion is the selling space stored in the article master 121.

More specifically, where the salesfloor map currently displayed on the display 25 is not a bottom layer map of the respective maps, when a selling space included in the currently displayed salesfloor map is designated by operating the touch panel 26, the first control section 51 causes the display 25 to display a lower layer map showing a more detailed salesfloor arrangement in the selling space, saved in the map information file 122.

Where the salesfloor map currently displayed on the display 25 is not a top layer map of the respective maps, when a place that is not a selling space included in the currently displayed salesfloor map is designated by operating the touch panel 26, the first control section 51 causes the display 25 to display an salesfloor map of a higher layer than the currently displayed salesfloor map, saved in the map information file 122.

Where the salesfloor map currently displayed on the display 25 is a bottom layer map of the respective maps, when a selling space included in the currently displayed salesfloor map is designated by operating the touch panel 26, the second control section 52 causes the display 25 to display the article information of an article whose display position is the selling space, saved in the article master 121.

After the second control section 52 causes the display 25 to display the article information of the article whose display position is the selling space designated by operating the touch panel 26, when a position that does not correspond to the currently displayed article information is designated by operating the touch panel 26, the first control section 51 causes the display 25 to display a bottom layer salesfloor map saved in the map information file 122.

The first control section 51 and the second control section 52 in the embodiment are realized, for example, by the CPU 20 of the customer terminal 2 executing the control program stored in the memory 22 or the like.

However, the first control section 51 and the second control section 52 may also be realized by the CPU 10 of the server device 1 executing the control program stored in the memory 12 or the like. Moreover, the first control section 51 and the second control section 52 may also be realized by the CPU 20 of the customer terminal 2 and the CPU 10 of the server device 1 operating collaboratively with each other.

### Operations

Next, operations of the server device 1 and the customer terminal 2 will be described. Here, an exemplary operation of the customer terminal 2 shown in FIG. 2 will be described.

The customer terminal 2 waits for start of operation in a standby mode when the shopping trolley 4 is placed in the trolley yard. When the shopping trolley 4 is taken out of the trolley yard by a customer visiting the store and the screen of the display 25 is touched, the customer terminal 2 starts operation.

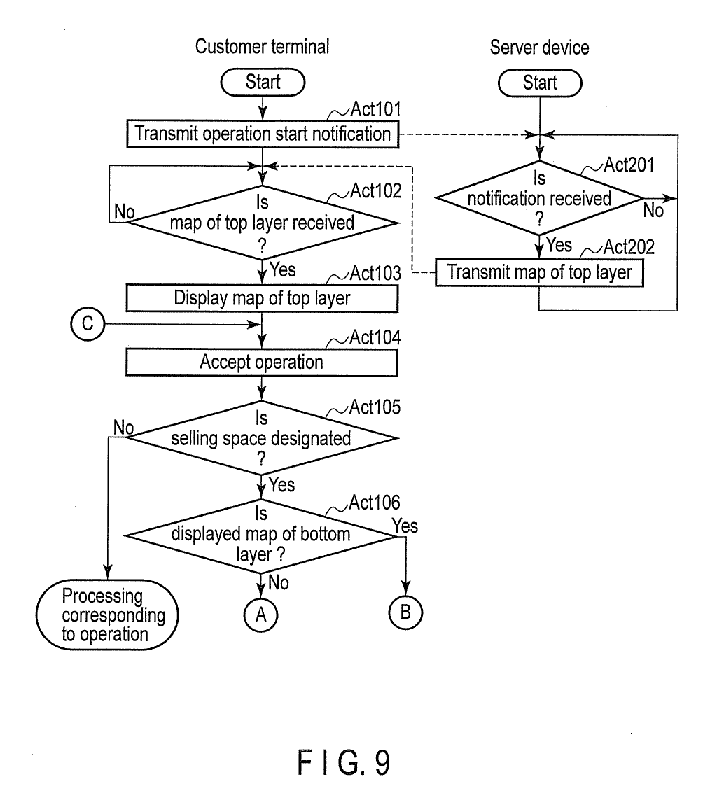

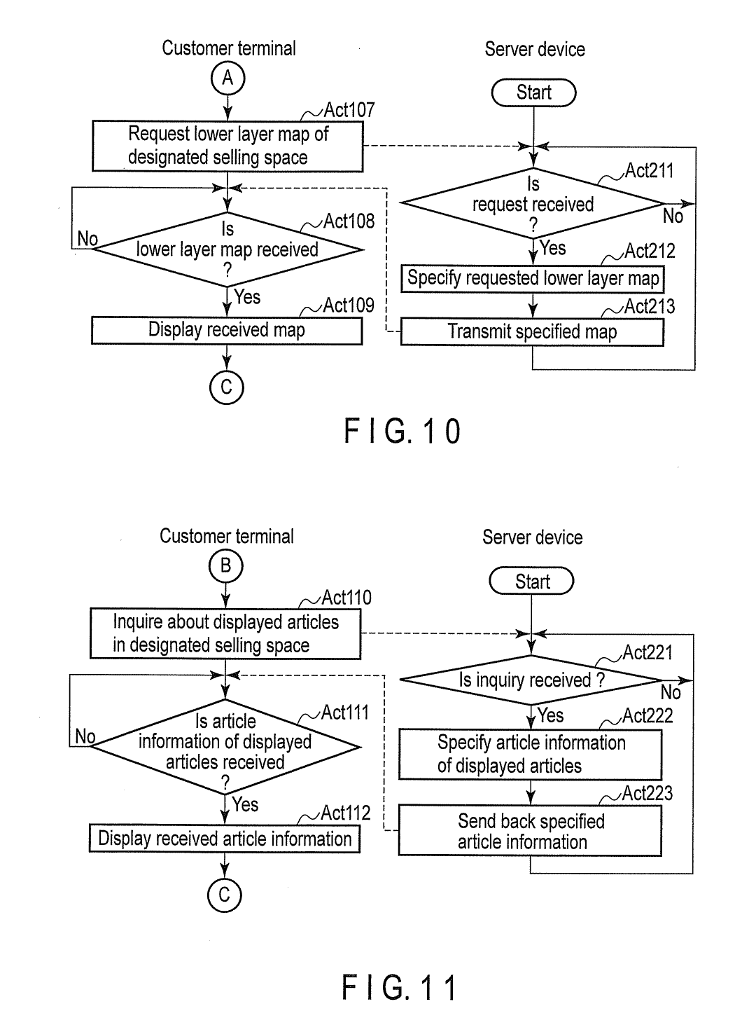

A flowchart of processing executed by the CPU 20 of the customer terminal 2 and the CPU 10 of the server device 1 after the start of operation of the customer terminal 2 is shown in FIG. 9, FIG. 10 and FIG. 11. The processing shown in FIG. 9 to FIG. 11 is realized by the CPU 20 executing the control program stored in the memory 22 and the CPU 10 executing the control program stored in the memory 12, and includes processing by the first control section 51 and the second control section 52.

Initially at the start of operation, the CPU 20 of the customer terminal 2 first transmits a notification of the start of operation via the wireless communication unit 21 (ACT 101). This notification is relayed at the access point and sent to the server device 1.

The CPU 10 of the server device 1 waits for reception of the notification of the start of operation from the customer terminal 2, parallel to other kinds of processing (No in ACT 201). Eventually, when the notification is received via the communication unit 11 (Yes in ACT 201), the CPU 10 sends back the top layer map constituting the map information file 122, that is, the overall salesfloor map 122a, via the communication unit 11 (ACT 202). The overall salesfloor map 122a that is returned is relayed at the access point and sent to the customer terminal 2 that is a transmission source of the notification. After that, the CPU 10 returns to the processing of ACT 201.

After transmitting the notification of the start of operation, the CPU 20 of the customer terminal 2 waits for reception of the overall salesfloor map 122a (No in ACT 102). Eventually, when the overall salesfloor map 122a sent back from the server device 1 as described above is received by the wireless communication unit 21 (Yes in ACT 102), the CPU 20 causes the display 25 to display the received overall salesfloor map 122a (ACT 103). In this manner, the salesfloor map of the top layer is read out from the map information file 122 and displayed on the display 25.

An exemplary screen of the display 25 where the overall salesfloor map 122a is displayed is shown in FIG. 12. As illustrated, on the overall salesfloor map 122a displayed on the display 25, positions of “cashier” as a checkout counter of the store and “doorway” are shown in addition to the positions of each selling space for “foodstuffs”, “daily necessities”, “hardware”, “timber” and the like belonging to the top categories.

In the state where the overall salesfloor map 122a is thus displayed on the display 25, the CPU 20 accepts an operation on the display screen of the display 25 (ACT 104). As the customer touches and operates the display screen of the display 25, the CPU 20 determines whether this operation is designation of the selling space for “foodstuffs”, “daily necessities”, “hardware”, “timber” or the like, or not (ACT 105). When the operation is not designation of the selling space (No in ACT 105), the CPU 20 executes processing corresponding to the operation.

Meanwhile, when the operation accepted in ACT 104 is a touch on a display position of one of the selling spaces, the CPU 20 determines that the operation is designation of the selling space (Yes in ACT 105). In this case, the CPU 20 determines whether the map that is currently displayed is the bottom layer map, that is, the detailed salesfloor map 122c, or not (ACT 106).

Since the map displayed now on the display 25 is the overall salesfloor map 122a, the CPU 20 determines that the currently displayed map is not the bottom layer map (No in ACT 106). In this case, the CPU 20 shifts to the processing shown in FIG. 10 and transmits a request command for a lower layer map of the designated selling space together with identification information of the selling space via the wireless communication unit 21 (ACT 107). This request command and the like are relayed at the access point and sent to the server device 1.

The CPU 10 of the server device 1 waits for reception of the identification information and the request command from the customer terminal 2, parallel to other kinds of processing (No in ACT 211). Eventually, when the identification information and the request command are received by the communication unit 11 (Yes in ACT 211), the CPU 10 specifies a lower layer map corresponding to the selling space indicated by the received identification information, from the map information file 122 (ACT 212). For example, the selling space designated in the example of FIG. 12 is “foodstuffs”, the enlarged salesfloor map 122b showing the selling space for foodstuffs is specified from the map information file 122 as the requested lower layer map. As the CPU 10 thus specifies the lower layer map, the CPU 10 sends back the lower layer map via the communication unit 11 (ACT 213). The lower layer map that is sent back is relayed at the access point and sent to the customer terminal 2 that is a transmission source of the request command and the like. After that, the CPU 10 returns to the processing of ACT 211.

After transmitting the request command and the like for the lower layer map, the CPU 20 of the customer terminal 2 waits for reception of the lower layer map (No in ACT 108). Eventually, when the lower layer map sent back from the server device 1 as described above is received by the wireless communication unit 21 (Yes in ACT 108), the CPU 20 causes the display 25 to display the received lower layer map (ACT 109). In this manner, the salesfloor map of the lower layer is read out from the map information file 122 and displayed on the display 25.

An exemplary screen on the display 25 where the enlarged salesfloor map 122b is displayed is shown in FIG. 13. This is the exemplary screen where the selling space of “foodstuffs” is designated on the overall salesfloor map 122a. As illustrated, on the enlarged salesfloor map 122b displayed on the display 25, the positions of “cashier” as a checkout counter of the store and “doorway” are shown in addition to each selling space for “vegetables”, “meat”, “seasoning”, “fish” and the like, which are the selling spaces of the intermediate categories belonging to the foodstuffs. In the enlarged salesfloor map 122b, the cashier arrangement is displayed more in detail than in the overall salesfloor map 122a.

In the state where the enlarged salesfloor map 122b is thus displayed on the display 25, the CPU 20 returns to the processing of ACT 104 of FIG. 9 and accepts an operation on the display screen of the display 25 again. In this case, as the customer touches and operates the display screen of the display 25 to designate one of the selling spaces included in the enlarged salesfloor map 122b that is currently displayed (Yes in ACT 105), the CPU 20 determines whether the currently displayed map is the bottom layer map, that is, the detailed salesfloor map 122c, or not (ACT 106).

Since the map displayed now on the display 25 is the enlarged salesfloor map 122b, the CPU 20 determines that the currently displayed map is not the bottom layer map (No in ACT 106). In this case, the CPU 20 shifts again to the processing shown in FIG. 10 and transmits a request command for a lower layer map of the designated selling space together with identification information of the selling space to the server device 1 (ACT 107). The identification information transmitted here includes information indicating a selling space of a top category corresponding to the enlarged salesfloor map 122b that is currently displayed, for example, “foodstuffs—seasoning”, and information indicating a selling space of a designated intermediate category.

As the CPU 10 of the server device 1 receives the identification information and the request command (Yes in ACT 211), the CPU 10 specifies a lower layer map corresponding to the selling space indicated by the received identification information, from the map information file 122 (ACT 212). For example, in the example of FIG. 13, when the selling space of “seasoning” is designated and “foodstuffs—seasoning” is received as the identification information, the detailed salesfloor map 122c showing the selling space of “seasoning” located in the selling space of “foodstuffs” is specified from the map information file 122 as the requested lower layer map. The lower layer map thus specified is sent back to the customer terminal 2 (ACT 213).

As the CPU 20 of the customer terminal 2 receives the lower layer map sent back from the server device 1 (Yes in ACT 108), the CPU 20 causes the display 25 to display the received lower layer map (ACT 109). An exemplary screen on the display 25 where the detailed salesfloor map 122c is displayed is shown in FIG. 14. The exemplary screen is shown in the case where the selling space of “seasoning” is designated on the enlarged salesfloor map 122b shown in FIG. 13. As illustrated, on the detailed salesfloor map 122c displayed on the display 25, positions of the selling spaces for “miso”, “soy sauce”, “dressing”, “vinegar” and the like, which are the selling spaces of the bottom categories belonging to the seasoning, are shown.

In the state where the detailed salesfloor map 122c is thus displayed on the display 25, the CPU 20 returns to the processing of ACT 104 of FIG. 9 and accepts an operation on the display screen of the display 25 again (ACT 104). In this case, as the customer touches and operates the display screen of the display 25 to designate one of the selling spaces included in the detailed salesfloor map 122c that is currently displayed (Yes in ACT 105), the CPU 20 determines whether the currently displayed map is the bottom layer map or not (ACT 106).

Since the map displayed now on the display 25 is the detailed salesfloor map 122c, the CPU 20 determines that the currently displayed map is the bottom layer map (Yes in ACT 106). In this case, the CPU 20 shifts to the processing shown in FIG. 11 and transmits an inquiry command for displayed articles in the designated selling space together with identification information of the selling space via the wireless communication unit 21 (ACT 110). The identification information transmitted here includes information indicating a selling space of a top category and a selling space of an intermediate category corresponding to the detailed salesfloor map 122c that is currently displayed, for example, “foodstuffs—seasoning—dressing”, and information indicating a selling space of a designated bottom category. The transmitted inquiry command and the like are relayed at the access point and sent to the server device 1.

The CPU 10 of the server device 1 waits for reception of the identification information and the inquiry command from the customer terminal 2, parallel to other kinds of processing (No in ACT 221). Eventually, when the identification information and the inquiry command are received by the communication unit 11 (Yes in ACT 221), the CPU 10 specifies article information of articles displayed in the selling space indicated by the received identification information, from the article master 121 (ACT 222). For example, in the example of FIG. 14, when the selling space of “dressing” is designated and “foodstuffs—seasoning—dressing” is received as the identification information, a record in which display position information that is identical to this identification information is set is specified from the article master 121.

As the article information of displayed articles is thus specified, the CPU 10 sends back the specified article information via the communication unit 11 (ACT 223). The article information sent back here is, for example, article name and unit price described in the record in the article master 121 corresponding to the displayed articles that are specified. The article information that is sent back is relayed at the access point and sent to the customer terminal 2 that is a transmission source of the inquiry command. After that, the CPU 10 returns to the processing of ACT 221.

After transmitting the inquiry command, the CPU 20 of the customer terminal 2 waits for reception of the article information of the displayed articles (No in ACT 111). Eventually, when the article information sent back from the server device 1 as described above is received by the wireless communication unit 21 (Yes in ACT 111), the CPU 20 causes the display 25 to display the received article information (ACT 112). In this manner, the article information of the displayed articles is read out from the article master 121 and displayed on the display 25.

An exemplary screen on the display 25 where the article information is displayed is shown in FIG. 15. This exemplary screen is in the case where the selling space for “dressing” is designated on the detailed salesfloor map 122c shown in FIG. 14. As illustrated, the article information of each article displayed in the selling space specified by “foodstuffs—seasoning—dressing”, such as “onion dressing 130 ml, ¥399 (tax-inclusive)”, is displayed on the display 25.

In the state where the article information is thus displayed on the display 25, the CPU 20 returns to the processing of ACT 104 of FIG. 9 and accepts an operation on the display screen of the display 25 again (ACT 104).

In the processing of ACT 104, when a position that is not the selling space is touched and operated (No in ACT 105) while the salesfloor maps 122b and 122c are displayed on the display 25 as shown in FIG. 13 and FIG. 14, the CPU 20 displays again the upper layer map that is displayed immediately before, instead of the currently displayed map. After that, the CPU 20 returns to the processing of ACT 104.

Moreover, in the processing of ACT 104, when a position that is not the article information is touched and operated (No in ACT 105) while the article information of the displayed article is displayed on the display 25 as shown in FIG. 15, the CPU 20 displays again the detailed salesfloor map 122c that is displayed immediately before, instead of the currently displayed article information. After that, the CPU 20 returns to the processing of ACT 104.

The processing of ACT 101 to ACT 112 ends when the shopping trolley 4 is returned to the trolley yard.

Even where the customer terminal 2 is a communication terminal such as a personal computer installed in the customer's home or the like, or a mobile phone, similar processing to ACT 101 to ACT 112 is executed. In that case, the display screen of the display may be operated by another operation unit such as a keyboard or mouse, instead of the touch panel.

As described above, in the article search system according to the embodiment, when a selling space included in a salesfloor map displayed on the display of the customer terminal 2 is designated, article information of articles displayed in the selling space is displayed on the display. With such a configuration, the customer can easily confirm the state of arrangement in the store's salesfloor and articles sold in each selling space.

Moreover, the salesfloor maps are hierarchically configured in order from a map showing rough divisions in terms of the salesfloor arrangement in the store to maps showing more detailed salesfloor arrangements. By sequentially designating selling spaces on the maps displayed on the display of the customer terminal 2, more detailed salesfloor arrangements can be confirmed. With such a configuration, the overall salesfloor arrangement to the detailed salesfloor arrangements can be easily visually recognized. Therefore, the speed of article search is improved.

### Modifications

The configuration disclosed in the embodiment can be modified in various ways. Specific modifications include the following, for example.

(1) In the above embodiment, an example where the salesfloor maps of one floor is hierarchized into the maps 122a to 122c is described. However, salesfloor maps of plural floors may be hierarchized to form the map information file 122. For example, in the case of operating the article search system for a store having plural floors, floor configuration view of the store may be added to the map information file 122 as a top layer salesfloor map. Moreover, in the case of operating the article search system for a store having plural buildings such as a main building and an annex, an arrangement view of each building may be added to the map information file 122 as a top layer salesfloor map.

(2) Alternatively, when the article information of one article is designated in the state where the article information of each article is displayed on the display of the customer terminal 2 as shown in FIG. 15, more detailed article information may be displayed. As the more detailed article information displayed in this case, various kinds of information can be employed, for example, manufacturer information, amount of discount from original price, explanation of features of the article and the like.

(3) Alternatively, the whole or a part of the processing described as being executed by the CPU 10 of the server device 1 in the above embodiment may be executed by the CPU 20 of the customer terminal 2. A part of the processing described as being executed by the CPU 20 of the customer terminal 2 in the above embodiment may be executed by the CPU 10 of the server device 1.

As an example, an embodiment without using the server device 1 will be described hereinafter.

In this case, the article master 121 and the map information file 122 are stored in the memory 22 of the customer terminal 2.

At the start of operation of the customer terminal 2, the CPU 20 reads out the top layer map, that is, the overall salesfloor map 122a, from the map information file 122 stored in the memory 22, instead of the processing of ACT 101 and ACT 102. In the processing of ACT 103, the CPU 20 causes the display 25 to display the overall salesfloor map 122a thus read out.

Moreover, instead of the processing of ACT 107 and ACT 108, the CPU 20 reads out the lower layer map of a selling space designated in ACT 104 immediately before, from the map information file 122 stored in the memory 22. In the processing of ACT 109, the CPU 20 causes the display 25 to display the lower layer map thus read out.

Furthermore, instead of the processing of ACT 110 and ACT 111, the CPU 20 reads out the article information of article displayed in the selling space designated in ACT 104 immediately before, from the article master 121 stored in the memory 22. In the processing of ACT 112, the CPU 20 causes the display 25 to display the article information thus read out.

By operating the CPU 20 of the customer terminal 2 as described above, the article search system can be realized without using the server device 1.

(4) In the above embodiment, an example where salesfloor maps and article information are displayed on the display 25 of the customer terminal 2 to provide information to the customer is described. However, the way of providing information to the customer is not limited to the displaying on the display 25. For example, salesfloor maps and article information may be printed by a printer built in or connected to the customer terminal 2 so that information can be provided to the customer. In this case, for example, a GUI for designating a selling space included in the printed salesfloor maps may be displayed on the display 25 so that the customer can operate the GUI by the touch panel 26 or other operation units to designate a selling space included in the printed salesfloor maps.

(5) In the above embodiment, an example where yen is used as a currency unit of a selling price of the article is described. However, in embodiment stage, parts corresponding to the yen in the above embodiment may be changed to an appropriate currency unit such as US dollar, euro, or renminbi, according to the country or region where the article search system, the information processing terminal or the information providing method of the exemplary embodiment is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An article search system comprising an information processing terminal, and a storage unit which stores a salesfloor map of a store and article information and a display position of an article sold,
wherein the information processing terminal comprises:
a display unit which displays information;
an operation unit which accepts a user's operation;
a first control section which causes the display unit to display the salesfloor map stored in the storage unit; and
a second control section which, when a selling space included in the salesfloor map displayed on the display unit is designated by operating the operation unit, causes the display unit to display the article information of an article whose display position is the selling space stored in the storage unit.

2. The system of claim 1, wherein plural salesfloor maps that are hierarchized are stored in the storage unit, and
where the salesfloor map currently displayed on the display unit is not a bottom layer map of the respective salesfloor maps, when a selling space included in the currently displayed salesfloor map is designated by operating the operation unit, the first control section causes the display unit to display a map of a lower layer than the currently displayed salesfloor map of the respective maps.

3. The system of claim 1, wherein plural salesfloor maps that are hierarchized in order from a map showing rough divisions of salesfloor arrangement of the store to a map showing a more detailed salesfloor arrangement are stored in the storage unit, and
where the salesfloor map currently displayed on the display unit is not a bottom layer map of the respective salesfloor maps, when a selling space included in the currently displayed salesfloor map is designated by operating the operation unit, the first control section causes the display unit to display a map of a lower layer showing a more detailed salesfloor arrangement in the salesfloor stored in the storage unit.

4. The system of claim 3, wherein, where the salesfloor map currently displayed on the display unit is not a top layer map of the respective salesfloor maps, when a place that is not a selling space included in the currently displayed salesfloor map is designated by operating the operation unit, the first control section causes the display unit to display a map of an upper layer than the currently displayed salesfloor map of the respective maps, stored in the storage unit.

5. The system of claim 1, wherein plural salesfloor maps that are hierarchized in order from a map showing rough divisions of salesfloor arrangement of the store to a map showing a more detailed salesfloor arrangement are stored in the storage unit, and
where the salesfloor map currently displayed on the display unit is a bottom layer map of the respective salesfloor maps, when a selling space included in the currently displayed salesfloor map is designated by operating the operation unit, the second control section causes the display unit to display article information of an article whose display position is the selling space stored in the storage unit.

6. The system of claim 5, wherein after the second control section causes the display unit to display the article information of the article whose display position is the selling space designated by operating the operation unit, when a position that does not correspond to the currently displayed article information is designated by operating the operation unit, the first control section causes the display unit to display the bottom layer salesfloor map saved in the storage unit.

7. The system of claim 1, wherein the information processing terminal is attached to a shopping trolley comprising a shopping basket.

8. An information processing terminal comprising:
a display unit which displays information;
an operation unit which accepts a user's operation;
a first control section which causes the display unit to display a salesfloor map stored in a storage unit which stores the salesfloor map of a store and article information and a display position of an article sold; and
a second control section which, when a selling space included in the salesfloor map displayed on the display unit is designated by operating the operation unit, causes the display unit to display the article information of an article whose display position is the selling space stored in the storage unit.

9. The terminal of claim 8, wherein plural salesfloor maps that are hierarchized are stored in the storage unit, and
where the salesfloor map currently displayed on the display unit is not a bottom layer map of the respective salesfloor maps, when a selling space included in the currently displayed salesfloor map is designated by operating the operation unit, the first control section causes the display unit to display a map of a lower layer than the currently displayed salesfloor map of the respective maps.

10. The terminal of claim 8, wherein plural salesfloor maps that are hierarchized in order from a map showing rough divisions of salesfloor arrangement of the store to a map showing a more detailed salesfloor arrangement are stored in the storage unit, and
where the salesfloor map currently displayed on the display unit is not a bottom layer map of the respective salesfloor maps, when a selling space included in the currently displayed salesfloor map is designated by operating the operation unit, the first control section causes the display unit to display a map of a lower layer showing a more detailed salesfloor arrangement in the salesfloor stored in the storage unit.

11. The terminal of claim 8, wherein plural salesfloor maps that are hierarchized in order from a map showing rough divisions of salesfloor arrangement of the store to a map showing a more detailed salesfloor arrangement are stored in the storage unit, and
where the salesfloor map currently displayed on the display unit is a bottom layer map of the respective salesfloor maps, when a selling space included in the currently displayed salesfloor map is designated by operating the operation unit, the second control section causes the display unit to display article information of an article whose display position is the selling space stored in the storage unit.

12. An information providing method for providing information to a user by using an information processing terminal comprising an output unit which outputs information and an operation unit which accepts a user's operation, the method comprising:
the information processing terminal causing the output unit to output a salesfloor map stored in a storage unit which stores the salesfloor map of a store and article information and a display position of an article sold; and
when a selling space included in the salesfloor map outputted by the output unit is designated by operating the operation unit, the information processing terminal causing the output unit to output article information of an article whose display position is the selling space stored in the storage unit.
